(19) United States
(12) Patent Application Publication
(10) Pub. No.: US 2004/0033835 A1
(43) Pub. Date: Feb. 19, 2004

(54) Device for illuminating palm-top TV game

(76) Inventor: Chang Chih Chao, Taipei (TW)

Correspondence Address: LAW OFFICE OF LIAUH & ASSOC., 4224 WAIALAE AVE, STE 5-388, HONOLULU, HI, 96816

(21) Appl. No.: 10/222,658

(22) Filed: Aug. 14, 2002

(51) Int. Cl. G06F 17/00

(52) U.S. Cl. 463/46

(57) ABSTRACT

A device for illuminating palm-top TV game includes a locating seat and a light casing pivotally connected to the locating seat via two angle arms. The locating seat is provided with retaining hooks for engaging with sockets provided at a rear side of a battery compartment of the palm-top TV game and thereby holds the latter to a top of the locating seat. The light casing is internally provided with a lighting tube to provide a sufficient light source to illuminate a display of the palm-top TV game attached to the top of the locating seat. The locating seat is also provided with elastic engaging members for detachably engaging with retaining holes provided at an upper edge of the TV game to ensure a firm attachment of the illuminating device to the TV game.

### BACKGROUND OF THE INVENTION

The present invention relates to a device for illuminating a palm-top TV game, and more particularly to an illuminating device for directly attaching to a palm-top TV game to provide sufficient light source to a display of the palm-top TV game without affecting manipulation of the TV game.

A palm-top TV game is portable and has a small volume. While the palm-top TV game is convenient for play at any place and at any time, it has a liquid crystal display (LED) of limited dimensions. Moreover, the LED display of the palm-top TV game is not provided with any back light and therefore has a very poor visual effect. A player tends to have sore eyes after viewing the small-sized LED display of the palm-top TV game 10 over a prolonged time. Therefore, playing the palm-top TV game for a long time is actually deemed as harmful to the player.

FIG. 1 is a front perspective view of a currently developed palm-top TV game that has a horizontal configuration. All keys or buttons for manipulating the horizontal-type palm-top TV game 10 are located at two lateral sides of the LED display 15 of the TV game 10, including a shift key 11 located at the left side of the display 15, two function keys 12 at the right side of the display 15, and left and right keys 13, 14 separately located at two outer ends an upper edge 16 of the TV game 10. Any other means provided on the palm-top TV game 10 are not supposed to shield the access to or hinder the manipulation of these keys 11, 12, 13, and 14, or to reversely affect the convenience in using these keys. The LED display 15 is centered at a front of the palm-top TV game 10. A battery compartment 17 is provided immediately behind the display 15, as shown in FIG. 2, making the TV game 10 have a central portion with an increased thickness as compared with two lateral portions thereof. This configuration enables a player to conveniently hold the palm-top TV game 10 at two lateral sides thereof and manipulate the keys 11, 12, 13 and 14 with two hands. The palm-top TV game 10 is provided at the upper edge 16 with a notch 161 for receiving a signal line (not shown) connected to an external apparatus to be used with the TV game 10, and two retaining holes 162 at two outer sides of the notch 161 for engaging with a retaining means (not shown) provided on the signal line plugged into the notch 161 to avoid the signal line from unexpectedly separating from the notch 161 due to a pull exerted on the signal line.

### SUMMARY OF THE INVENTION

A primary object of the present invention is to provide a device for illuminating a palm-top TV game. The illuminating device is easily but firmly associated with the palm-top TV game through engagements of retaining hooks and elastic engaging members provided on the device with sockets and retaining holes provided on the TV game, respectively.

To achieve the above and other objects, the device for illuminating the palm-top TV game provided by the present invention mainly includes a locating seat and a light casing. The locating seat is provided at an upper front edge with two retaining hooks for engaging with two sockets originally provided at a lower edge of a battery compartment of the TV game for engaging with two hooks on a battery compartment cover, and at a rear portion with two elastic engaging members for engaging with two retaining holes provided at the upper edge of the TV game. Therefore, the palm-top TV game with the battery compartment cover removed therefrom may be easily attached to a top of the locating seat through engagements of the retaining hooks and the elastic engaging members provided on the device with the sockets and the retaining holes provided on the TV game, respectively. The light casing is internally provided with a lighting tube to provide a sufficient light source for illuminating an LED display of the TV game. The light casing is pivotally connected to the rear side of the locating seat through two angle arms. Upper ends of the angle arms are provided with a plurality of cavities for detachably and selectively engaging with two protuberances provided at two lower outer ends of the light casing, so that the light casing is pivotally turnable to locate at different angles of elevation relative to the locating seat, and accordingly, the palm-top TV game, to best suitably illuminate the latter.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of a palm-top TV game;

FIG. 2 is a rear perspective view of the palm-top TV game of FIG. 1;

FIG. 3 is an assembled perspective view of a device for illuminating a palm-top TV game according to an embodiment of the present invention;

FIG. 4 is an exploded perspective view of the device for illuminating a palm-top TV game shown in FIG. 3;

FIG. 5 is a perspective view showing the illuminating device of FIG. 3 associated with the palm-top TV game of FIG. 1;

FIG. 6 is a side view of FIG. 5; and

FIG. 7 is a perspective view of a device for illuminating palm-top TV game according to another embodiment of the present invention.

### DETAILED DESCRIPTION OF THE PREFERRED EMBODIMENTS

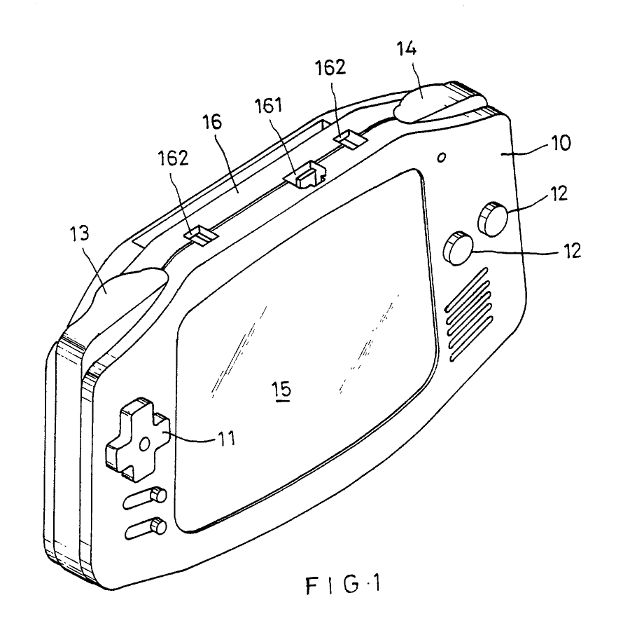

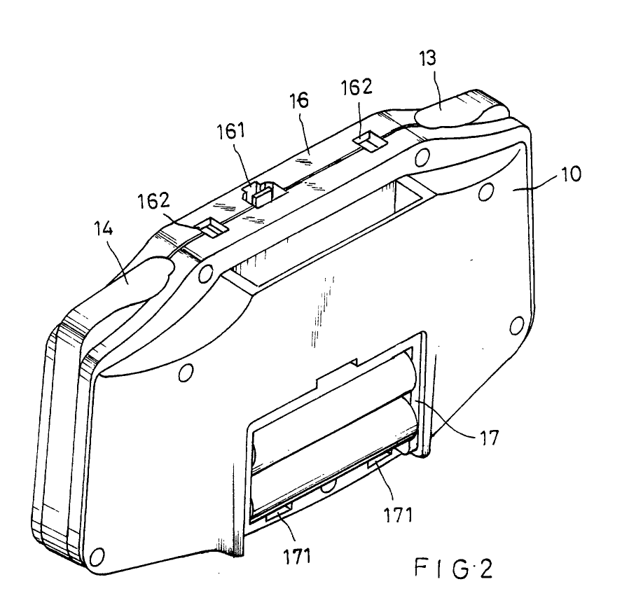

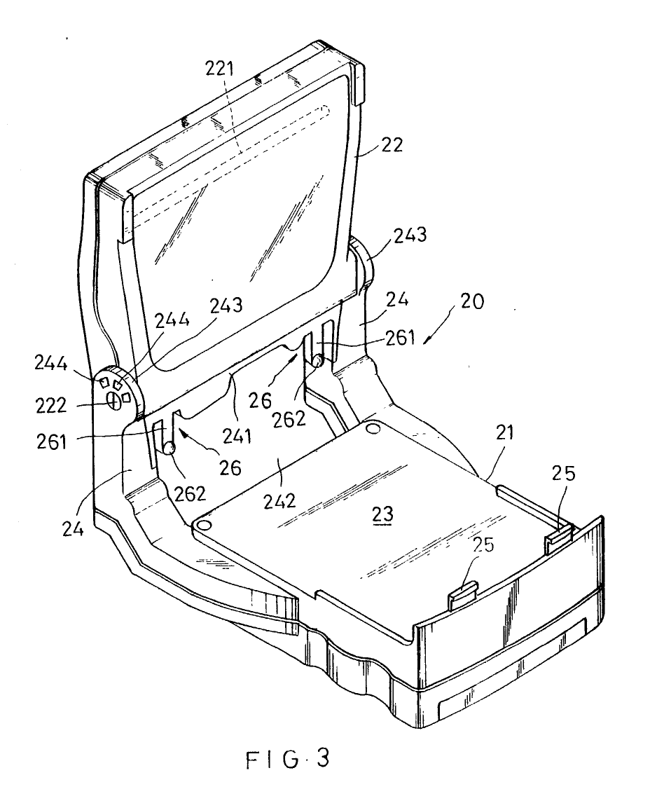

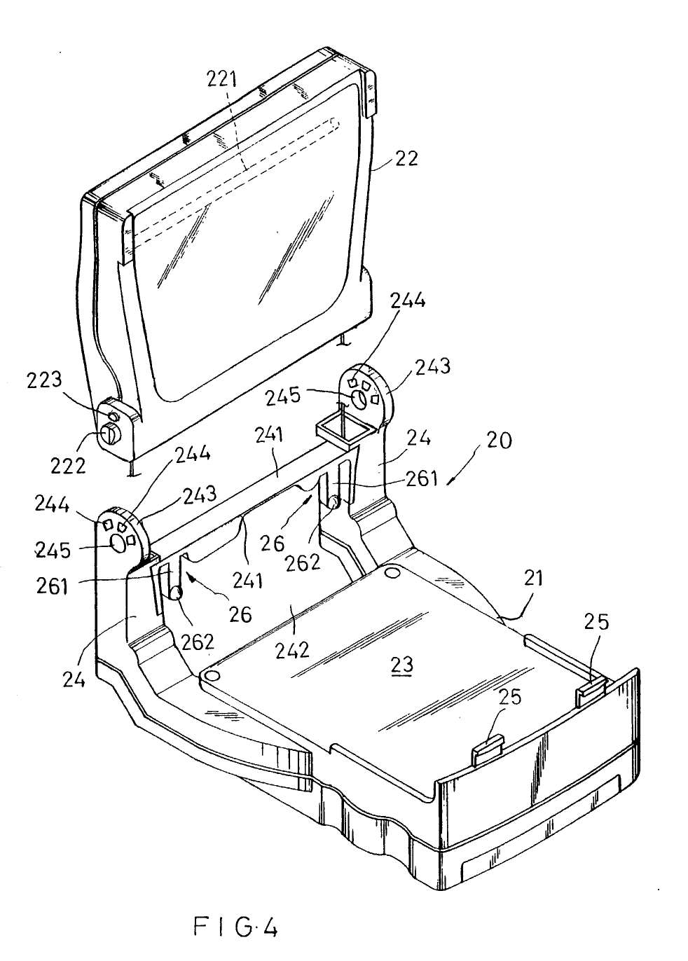

Please refer to FIGS. 3 and 4 that are assembled and exploded perspective views, respectively, of a device 20 for illuminating palm-top TV game according to an embodiment of the present invention. The illuminating device 20 of the present invention is designed for using with a palm-top TV game 10 shown in FIGS. 1 and 2 having a horizontal configuration. As shown in FIG. 3, the illuminating device 20 mainly includes a locating seat 21 and a light casing 22. An upper surface 23 of the locating seat 21 is designed to fitly contact with a back of the palm-top TV game 10 after a cover (not shown) of the battery compartment 17 is removed. Two angle arms 24 are extended from two lateral rear ends of the locating seat 21 to pivotally connect at upper ends to two lower outer ends of the light casing 22. A lighting tube 221 is mounted inside the light casing 22 to provide a light source.

The locating seat 21 is provided at an upper front edge with two upward projected retaining hooks 25 that are adapted to engage with two sockets 171 provided at a lower edge of the battery compartment 17 on the palm-top TV game 10. As can be more clearly seen from FIG. 4, a crossbar 241 is extended between two upper ends of the two angle arms 24. Two elastic engaging members 26 are downward extended from two lower outer ends of the crossbar 241. The elastic engaging members 26 are two leaf springs 261 each having a dot 262 provided at a lower front end thereof for detachably engaging with the two retaining holes 162 provided at the upper edge 16 of the palm-top TV game 10. By engaging the retaining hooks 25 with the sockets 171 and the dots 262 with the retaining holes 162, the palm-top TV game 10 is securely attached to the illuminating device 20 of the present invention.

After the palm-top TV game 10 is attached to the illuminating device 20, the upper surface 23 of the locating seat 21 of the illuminating device 20 automatically closes the battery compartment 17 of the palm-top TV game 10. The two angle arms 24 together define a space 242 between them to provide an access for a cartridge and signal lines (not shown) to the palm-top TV game 10.

Please refer to FIG. 4. Each angle arm 24 has an expanded uppermost head 243 on which a through hole 245 is formed for rotatably engaging with a boss 222 sideward projected from a lower outer end of the light casing 22, so that the light casing 22 is pivotally turnable about the bosses 222 and the through holes 245 relative to the locating seat 21. The expanded heads 243 of the angle arms 24 are further provided above the through holes 245 with a plurality of angularly spaced dents or cavities 244, and the lower outer ends of the light casing 22 are further provided above the bosses 222 with two protuberances 223, such that the protuberances 223 are detachably and selectively engaged with the dents or cavities 244. By turning the light casing 22 relative to the locating seat 21 with the protuberances 223 engaging with different pairs of cavities 244, the light casing 22 may be located at different angle of elevation to provide optimal light source to the palm-top TV game 10.

The locating seat 21 is internally provided with batteries (not shown) to provide necessary power to the lighting tube 221 inside the light casing 22.

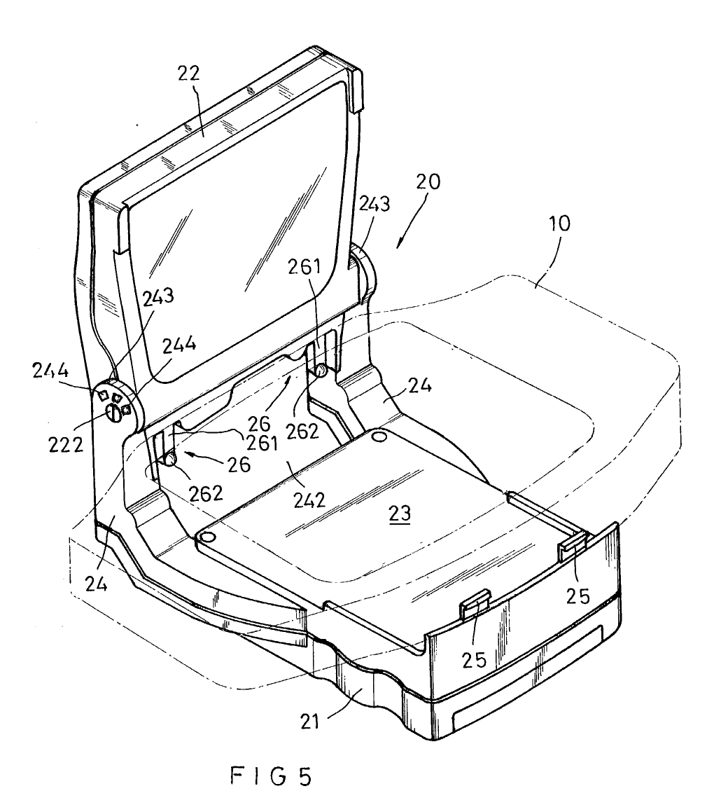

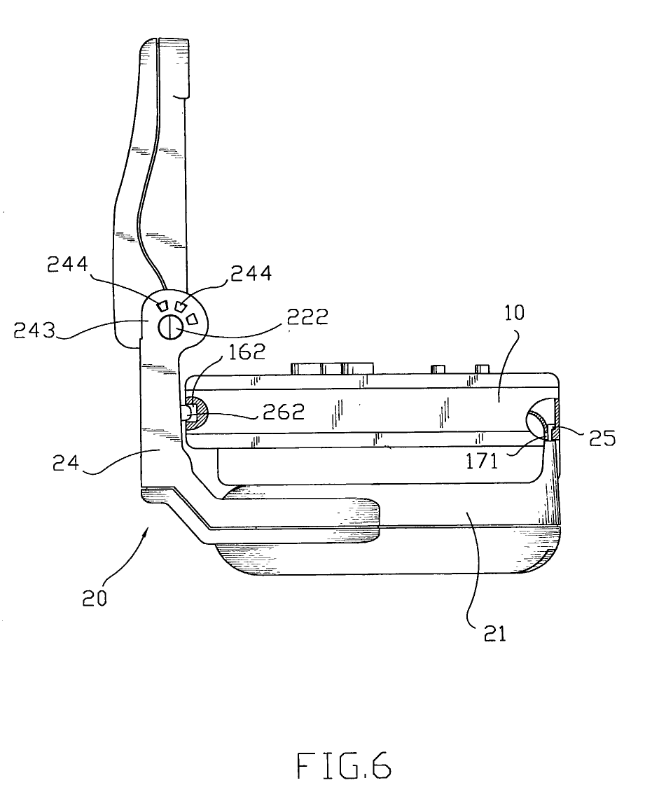

FIGS. 5 and 6 are perspective and side views, respectively, showing the illuminating device 20 and the palm-top TV game 10 in an associated relation.

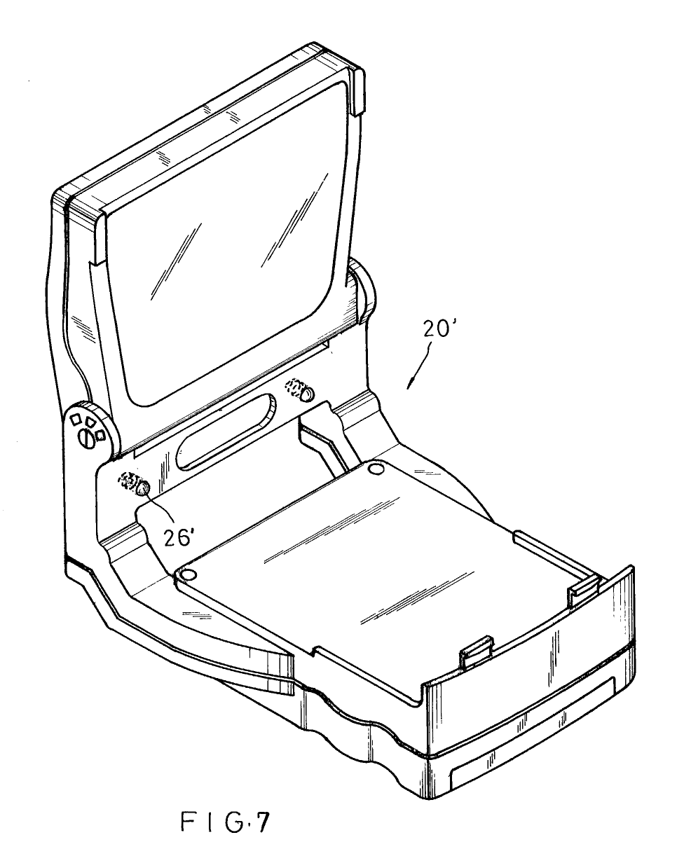

FIG. 7 shows an illuminating device 20′ for palm-top TV game according to another embodiment of the present invention. In this embodiment, the device 20′ includes two elastic engaging members in the form of two spring-loaded balls 26′. Due to a structural elasticity of the springs connected to the balls 26′, the balls 26′ could be elastically pushed forward to engage with the retaining holes 162 provided at the upper edge of the palm-top TV game 10 to firmly connect the palm-top TV game 10 to the illuminating device 20′.

With the above arrangements, the illuminating device of the present invention can be easily and securely engaged with the palm-top TV game to provide a sufficient light source to the display of the TV game without affecting normal manipulation of keys thereof. A user's eyes are therefore well protected.

What is claimed is:

1. A device for illuminating palm-top TV game, said palm-top TV game having a horizontal configuration with all manipulating keys thereof provided at two lateral sides of a display of said TV game, a battery compartment immediately behind said display, two sockets provided at a lower edge of said battery compartment, and two retaining holes provided at an upper edge of said palm-top TV game, said illuminating device comprising a locating seat and a light casing:
said locating seat having an upper surface adapted to fitly contact with a rear side of said palm-top TV game with a cover of said battery compartment removed therefrom, and having two upward projected retaining hooks provided at an upper front edge for engaging with said two sockets provided at the lower edge of said battery compartment of said TV game; two angle arms being extended from two rear outer sides of said locating seat to pivotally connect two upper ends to two lower outer ends of said light casing; a crossbar being extended between the two upper ends of said two angle arms and having two elastic engaging members provided at two lower outer ends of said crossbar for detachably engaging with said two retaining holes provided at the upper edge of said TV game and thereby firmly hold said palm-top TV game to said illuminating device; and
said light casing being internally provided with a light tube to provide a light source for illuminating the display of said palm-top TV game.

2. The device for illuminating palm-top TV game as claimed in claim 1, wherein said elastic engaging members are two leaf springs, each of which has a dot provided at a lower front end thereof.

3. The device for illuminating palm-top TV game as claimed in claim 1, wherein said elastic engaging members are a pair of spring-loaded balls.

4. The device for illuminating palm-top TV game as claimed in claim 1, wherein said light casing is provided at the lower outer ends with two sideward projected bosses and two protuberances separately located above said bosses, and said angle arms are provided at the two upper ends with two through holes and two sets of a plurality of cavities located above said two through holes; and said light casing being pivotally connected to said angle arms by engaging said bosses with said through holes and said protuberances with any one pair of said cavities, so that said light casing is able to locate at a selected angle of elevation relative to said locating seat and accordingly, said palm-top TV game.
